(19) United States
(12) Patent Application Publication
(10) Pub. No.: US 2015/0343996 A1
(43) Pub. Date: Dec. 3, 2015

(54) Wiper Motor Apparatus For Vehicle

(71) Applicant: DY AUTO Corporation, Asan-si (KR)

(72) Inventors: Sung Jin Hong, Incheon (KR); Hwang Yong Roh, Incheon (KR)

(21) Appl. No.: 14/675,088

(22) Filed: Mar. 31, 2015

(30) Foreign Application Priority Data
Jun. 3, 2014 (KR) 10-2014-0067783

(51) Int. Cl. B60S 1/24; B60S 1/18; B60S 1/08

(52) U.S. Cl. CPC B60S 1/24; B60S 1/08; B60S 1/185

(57) ABSTRACT

Provided is a wiper motor apparatus for a vehicle, which drives a wiper apparatus for washing windows of a vehicle. The apparatus includes a pair of stoppers configured to prevent a cantilever-type crank fixed on an end of an output shaft of the wiper motor apparatus from rotating beyond a predetermined range of angle. The pair of stoppers are integrally formed with a housing of the wiper motor apparatus.

### FIELD OF THE INVENTION

One or more exemplary embodiments relate to a wiper motor apparatus for driving windshield wipers configured to remove foreign substances on a front or rear window of a vehicle so as to secure a driver's view.

### BACKGROUND OF THE INVENTION

In general, a wiper apparatus is installed in a vehicle to wash foreign substances on windows of the vehicle. The wiper apparatus is configured to perform an operation by controlling wiper blades to make a reciprocal rotary motion with respect to a shaft through a wiper motor driven by electric power. In general, in a wiper apparatus employed in a vehicle, a pair of wiper blades may be coupled to each other through a linkage module and driven by one wiper motor to wash a windshield of the vehicle. In this case, an output shaft of the wiper motor continuously rotates in one direction, and the linkage module coupled to the output shaft of the wiper motor drives the wiper blades to make a reciprocal rotary motion in left and right directions. Recently, there is a growing trend of employing, as a wiper motor, a reversible electronic motor whose output shaft may rotate in a clockwise/counter-clockwise direction, so that the linkage module may be simplified or omitted.

When an electronic motor that may be driven to make a reciprocal rotary motion is employed, a complicated linkage module may be simplified or omitted. Thus, a wiper apparatus may be manufactured in a simple structure while reducing the weight and size thereof, thereby increasing the degree of freedom of a package of a vehicle and reducing manufacturing costs.

An example of such an electronic wiper motor apparatus has been disclosed in Korean Patent No. 0808572. Basically, an electronic wiper motor apparatus employs a reversible motor that may rotate in a clockwise/counter-clockwise direction. Such an electronic wiper motor apparatus may, however, malfunction in some cases. In this case, when wiper blades of a vehicle rotate beyond a predetermined range, the wiper blades, wiper arms and the body of the vehicle may be damaged. Thus, a physical mechanism is installed to prevent the wiper blades of the vehicle from rotating beyond the predetermined range. Most electronic wiper motor apparatuses include a stopper structure that prevents a crank coupled to an output shaft from rotating beyond a predetermined range so as to prevent wiper blades from rotating beyond a predetermined range.

However, in a wiper motor apparatus according to the related art, a stopper having the above function is included in a bracket separated from a housing of wiper motor. Thus, additional components should be further installed to employ a stopper structure, and the number of components and manufacturing costs are thus increased. Also, since the stopper included in the bracket is arranged to be relatively distant from the crank, the height of the stopper should be increased. Thus, the strength of the stopper may be lowered and the stopper may be thus broken during an operation thereof.

### SUMMARY OF THE INVENTION

One or more exemplary embodiments include a wiper motor apparatus for a vehicle, which is an improvement of an electronic wiper motor apparatus capable of rotating in a clockwise/counter-clockwise direction, has high durability, and may be manufactured with a small number of components and at low costs.

Additional aspects will be set forth in part in the description which follows and, in part, will be apparent from the description, or may be learned by practice of the presented embodiments.

According to one or more exemplary embodiments, a wiper motor apparatus for a vehicle which drives a wiper apparatus for washing windows of a vehicle includes a pair of stoppers configured to prevent a cantilever-type crank, one end of which is fixed on one end of an output shaft of the wiper motor apparatus from rotating beyond a predetermined range of angle. The pair of stoppers are integrally formed with a housing of the wiper motor apparatus, protrude in a direction of the output shaft of the wiper motor apparatus, and are spaced a predetermined angle from a circumference of the output shaft. Another end of the crank is bent in a direction opposite a direction in which the output shaft protrudes to form a stop projection that is caught by the pair of stoppers while the crank rotates.

A width of the stop projection may be less than that of a crank body.

The pair of stoppers may include reinforcement units connecting the pair of stoppers with the housing smoothly.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a wiper motor apparatus for a vehicle according to an exemplary embodiment;

FIG. 2 is a side view of the wiper motor apparatus for a vehicle of FIG. 1;

FIG. 3 is a plan view of the wiper motor apparatus for a vehicle of FIG. 1;

FIG. 4 is a diagram particularly illustrating a stopper structure of the wiper motor apparatus for a vehicle of FIG. 1; and

FIG. 5 is a cross-sectional view taken along line V-V of FIG. 3.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

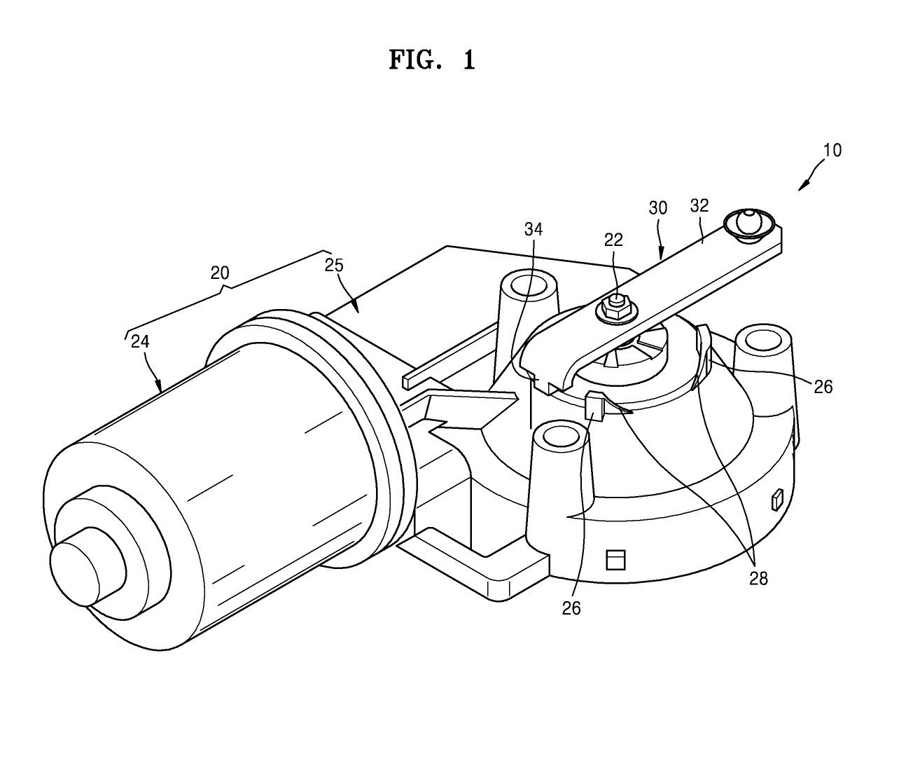

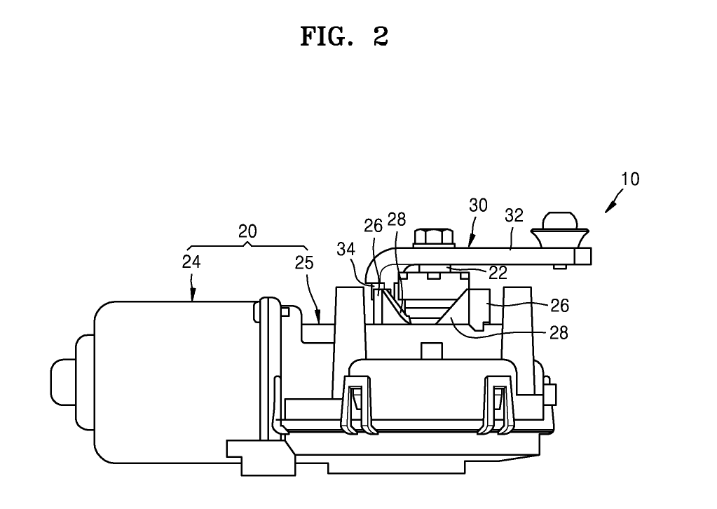

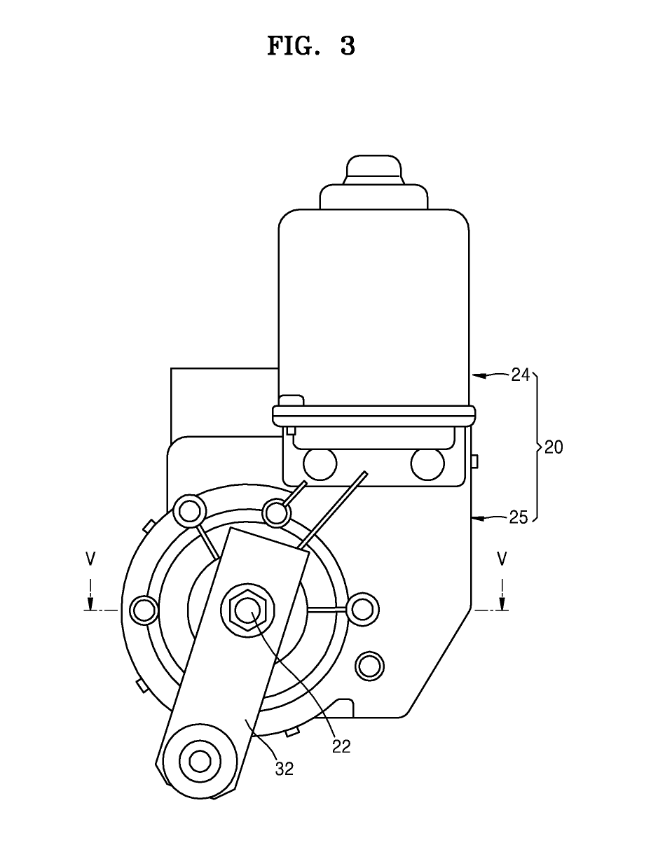

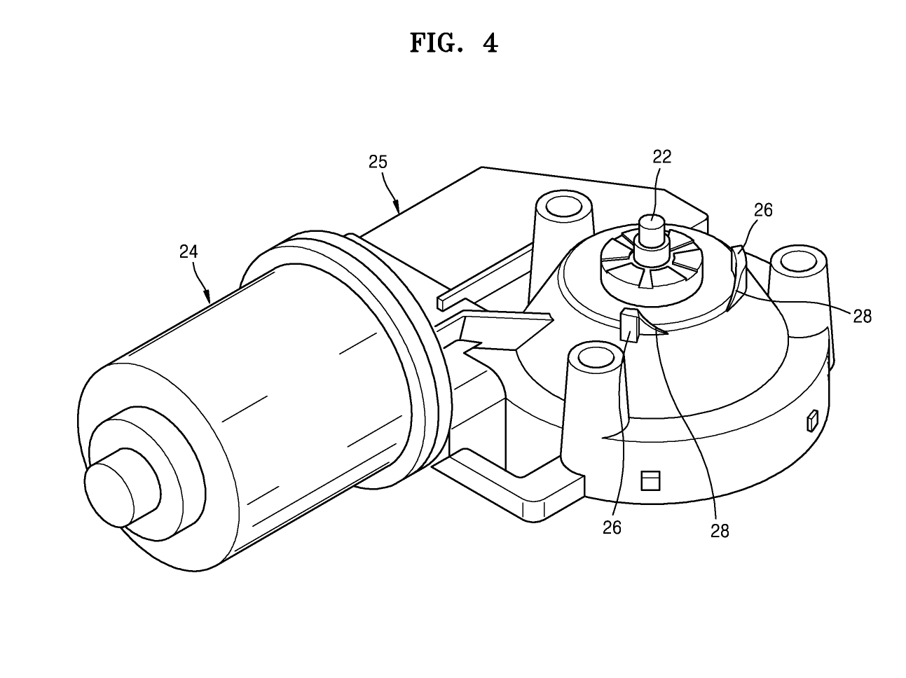

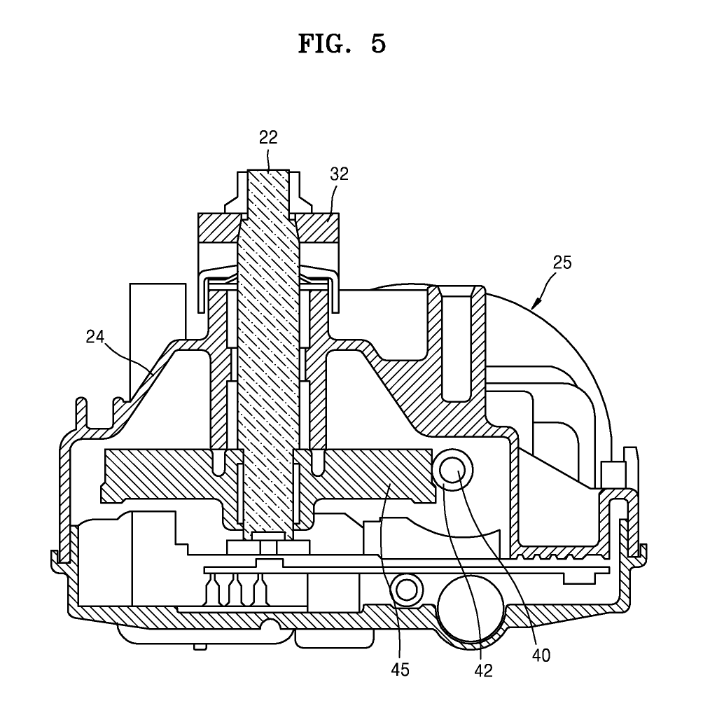

FIG. 1 is a perspective view of a wiper motor apparatus for a vehicle according to an exemplary embodiment. FIG. 2 is a side view of the wiper motor apparatus for a vehicle of FIG. 1. FIG. 3 is a plan view of the wiper motor apparatus for a vehicle of FIG. 1. FIG. 4 is a diagram particularly illustrating a stopper structure of the wiper motor apparatus for a vehicle of FIG. 1. FIG. 5 is a cross-sectional view taken along line V-V of FIG. 3.

Referring to FIGS. 1 to 5, a wiper motor apparatus 10 for a vehicle according to an exemplary embodiment (hereinafter referred to as ‘the wiper motor apparatus 10’) is configured to drive a wiper apparatus that washes windows of a vehicle.

The wiper motor apparatus 10 includes a housing 20, a stopper 26, a crank 30, and a stop projection 34.

The housing 20 forms the exterior of the wiper motor apparatus 10. The housing 20 includes a motor housing 24 and a gear housing 25. The motor housing 24 is a metallic housing that forms a stator of a motor device. A plurality of permanent magnets are arranged on an inner circumference of the motor housing 24. A rotation axis 40, a core, and a coil wound around the core are arranged in an inner space of the motor housing 24. A worm 42 and a worm wheel 45 are included in the gear housing 25. The gear housing 25 may be manufactured by, for example, aluminum die casting. The worm 42, the worm wheel 45, and the like installed in the gear housing 25 change a rotational direction and torque of the rotation axis 40. An output shaft 22 protrudes to the outside of the gear housing 25. The crank 30 which will be described below is fixed on the output shaft 22.

A pair of stoppers 26 are provided with the gear housing 25. The pair of stoppers 26 are integrally formed with the gear housing 25. The pair of stoppers 26 protrude in a direction of the output shaft 22 of the wiper motor apparatus 10. In detail, the pair of stoppers 26 protrude from a surface of the gear housing 25. The pair of stoppers 26 are arranged to be spaced a predetermined angle from the circumference of the output shaft 22. In general, the pair of stoppers 26 may be arranged to be spaced by 160 degrees with respect to the output shaft 22. The pair of stoppers 26 prevent the crank 30 which will be described below from rotating beyond a predetermined range of angle.

The pair of stoppers 26 each include a reinforcement unit 28. The reinforcement unit 28 connects the pair of stoppers 26 with the housing 20 smoothly. The reinforcement unit 28 prevents the pair of stoppers 26 from being damaged, e.g., being broken, when a force is applied to the pair of stoppers 25 by the stop projection 34 of the crank 30 in a structure in which the pair of stoppers 26 protrude in the form of a cantilever from the gear housing 25.

One end of the crank 30 is fixed on one end of the output shaft 22 of the wiper motor apparatus 10. The crank 30 is a cantilever type structure. The crank 30 makes a reciprocal rotary motion while being fixed on the output shaft 22. Although not shown, wiper arms or a link structure is coupled with another end of the crank 30.

The crank 30 includes a crank body 32 and the stop projection 34.

The crank body 32 includes a coupling hole via which the crank 30 is coupled to the output shaft 22. The crank body 32 may be a bar-type structure. A ball joint to which the wiper arms or the link structure is coupled may be coupled with the other end of the crank body 32.

The stop projection 34 is formed by bending the other end of the crank 30 in a direction opposite a direction in which the output shaft 22 protrudes. The stop projection 34 is a structure designed to be caught by the pair of stoppers 26 while the crank 30 rotates. When the stop projection 34 is in contact with the pair of stoppers 26, the rotation of the crank 30 is stopped. The stop projection 34 and the pair of stoppers 26 prevent wiper blades, the wiper arms, and a vehicle body coupled to the wiper motor apparatus 10 from being damaged when the wiper motor apparatus 10 malfunctions. A width of the stop projection 34 may be less than that of the crank body 32. When the width of the stop projection 34 is less than that of the crank body 32, the distance between the pair of stoppers 26 may be small. When the distance between the pair of stoppers 26 is small, the size of the reinforcement unit 28 may be increased to improve the durability of the pair of stoppers 26.

Effects of an exemplary embodiment will now be described in detail by describing an operation of the wiper motor apparatus 10 in a state in which the wiper motor apparatus 10 is installed in a vehicle.

Referring to FIGS. 1 to 5, when the wiper motor apparatus 10 is powered on, a rotor rotates about a stator due to an electromagnetic interaction between the stator and the rotor in the motor housing 24. When the rotor rotates, the rotation axis 40 rotates. The worm 42 formed on an end of the rotation axis 40 rotates the worm wheel 45 accommodated in the gear housing 25. The worm 42 and the worm wheel 45 change a rotational direction and torque of the rotation axis 40. Thus, the output shaft 22 makes a reciprocal rotary motion. Since the crank 30 is fixed on the output shaft 22, the crank 30 makes a reciprocal rotary motion as the output shaft 22 makes a reciprocal rotary motion. Since the wiper arms or the link device is coupled to the other end of the crank 30, windows of a vehicle are washed by wiper blades included in the wiper arms.

In this case, the wiper motor apparatus 10 reversibly makes a reciprocal rotary motion. Thus, the crank 30 makes a reciprocal rotary motion about the output shaft 22 within a predetermined range of angle. The wiper motor apparatus 10 may, however, malfunction due to an electric or mechanical defect thereof. In this case, the output shaft 22 may rotate beyond a predetermined range. When the stop projection 34 is caught by the pair of stoppers 26, the rotation of the crank 30 is stopped. As described above, the crank 30 may be prevented from physically rotating beyond the predetermined range of angle by the stop projection 34 and the stopper 26. In this case, in general, since a torque of the output shaft 22 is considerably high, the pair of stoppers 26 may be broken. However, the durability of the pair of stoppers 26 may be improved due to the reinforcement units 28 according to the present embodiment and may be thus prevented from being broken.

Also, since the pair of stoppers 26 are integrally formed with the gear housing 25, the number of components of the wiper motor apparatus 10 is smaller than in the related art in which a stopper is included in a bracket assembled separate from a gear housing, thereby decreasing the weight and manufacturing costs of the wiper motor apparatus 10.

Also, since the stop projection 34 is formed by bending the other end of the crank 30 in a direction opposite the direction in which the output shaft 22 protrudes, the height of the pair of stoppers 26 may be set to be much lower than that in the related art. As a result, since the height of the pair of stoppers 26 which is a cantilever structure may be set to be lower than that in the related art, the strength of the pair of stoppers 26 may remarkably increase, thereby improving the durability thereof.

As described above, according to the one or more of the above exemplary embodiments, a wiper motor apparatus may have a simple structure and high durability and may be manufactured with a small number of components by integrally forming a pair of stoppers, which is configured to limit a range of rotation of a crank fixed on a output shaft of a motor, with a motor housing. Also, according to the one or more of the above exemplary embodiments, a stop projection of the crank is formed by bending the other end of the crank in a direction opposite a direction of the output shaft of the motor protrudes. Thus, since the height of the pair of stoppers may be set to be low, the strength of the pair of stoppers may be improved to increase the durability of the wiper motor apparatus.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A wiper motor apparatus for a vehicle which drives a wiper apparatus for washing windows of a vehicle, the apparatus comprising a pair of stoppers configured to prevent a cantilever-type crank, one end of which is fixed on one end of an output shaft of the wiper motor apparatus from rotating beyond a predetermined range of angle,
wherein the pair of stoppers are integrally formed with a housing of the wiper motor apparatus, protrude in a direction of the output shaft of the wiper motor apparatus, and are spaced a predetermined angle from a circumference of the output shaft, and
another end of the crank is bent in a direction opposite a direction in which the output shaft protrudes to form a stop projection that is caught by the pair of stoppers while the crank rotates.

2. The apparatus of claim 1, wherein a width of the stop projection is less than that of a crank body.

3. The apparatus of claim 1, wherein the pair of stoppers comprise reinforcement units connecting the pair of stoppers with the housing smoothly.
